(19) United States
(12) Patent Application Publication
(10) Pub. No.: US 2006/0218512 A1
(43) Pub. Date: Sep. 28, 2006

(54) System and method for rapid prototyping of asic systems

(75) Inventors: Tughrul Arslan, Edinburgh (GB); Robert Graham, Edinburgh (GB); Robert Thomson, Edinburgh (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: University Court of the University of Edinburgh, Edinburgh (GB)

(21) Appl. No.: 10/543,687

(22) PCT Filed: Jan. 29, 2004
(86) PCT No.: PCT/GB04/00404

§ 371 Date: May 2, 2006

(30) Foreign Application Priority Data
Jan. 29, 2003 (GB) 0301993.2

(51) Int. Cl. G06F 17/50; G06N 3/12; G06F 15/18

(52) U.S. Cl. 716/4; 703/2; 706/13; 706/921

(57) ABSTRACT

A method for designing a computational device or circuit having one or more desired characteristics, preferably input and/or output characteristics. The method involves using an inner, iterative search that is preferably used within one or more genetic operators. As a first step, one of a population of computational circuits or devices is selected. Once this is done a point in the selected circuit or device is chosen and characterised in terms of the circuit inputs and/or outputs. A parameter or characteristic associated with the selected point is then modified and the point is re-characterised. This is repeated to provide characterisations for a plurality of modified versions of the circuit. Then, the circuit that has characteristics closest to the desired characteristics is identified and added to the population of circuits, and the inner search loop is repeated for another one of the population. At the same time, an outer search, preferably within an evolutionary algorithm, is used to iteratively search the population to determine the circuits or devices having characteristics that are closest to the desired characteristics.

The present invention relates to an enhanced design automation (EDA) tool for the rapid prototyping of digital circuit designs. The invention also relates to evolutionary methods for devising computational devices, and in particular to the synthesis of digital circuits from a behavioural specification.

In this modern era of rapid evolution in the electronics industry, circuit designers are eager to be abreast of the latest EDA tools and technologies. However, due to the complexity of leading edge design tools and their associated costs, a significant proportion of design companies are discouraged from using these. Unfortunately, this relegates financially constrained companies to using rather dated software solutions in an attempt to provide what should be classed as state of the art hardware products for their customers.

In an attempt to curb costs and enhance production efficiency, a design agency may decide to upgrade their design and/or verification tool-kit to ensure compliance with the latest technologies. Not only is this expensive, but also potentially time consuming. After acquiring the appropriate software packages, they need to be installed on site. Considering the heavily bloated distributions provided by the majority of vendors, significant resources might need to be allocated to the new set-up. Computer processing and storage requirements may need to be reviewed. Assuming that computational resources suffice, a significant proportion of time then has to be dedicated to configuring a stable and reliable installation. Once up and running, optimum efficiency can only be achieved via constantly tweaking and patching these complex CAD environments. Because providing dedicated support staff is expensive, especially to small to medium sized enterprises, this chore is all to often allocated to the design engineers themselves. This arrangement significantly distracts the small company from its core competency—that of designing integrated circuits.

With the ever-escalating complexities of modern integrated circuits, designers are increasingly turning to technology libraries of ‘Intellectual Properties (IPs)’ or ‘virtual component blocks’. These are pre-verified hardware core modules designed primarily for reuse as functional blocks in larger architectures. Through the plugging together of these cores, larger designs or even full ASIC solutions can be realised. The main advantage of this approach is that complex applications can be rapidly assembled by linking together desired cores, providing their interfaces are compatible. This means that designs are no longer constructed from the ground up but rather from the pedestals of the core building blocks, which in turn means that the level of expertise required to implement integrated designs is greatly diminished.

Typically, pre-designed modules are fully optimised in terms of power consumption and/or silicon area, both of which are traits precluded to the realms of highly experienced design engineers. Reinforcing the physical benefits of the IP approach is the fact that each core is guaranteed to synthesis error free to a particular silicon technology. Hence, design engineers need only verify and debug the interfacing between the cores they have chosen to embed in their designs. Because of this, the time to market can be minimised.

Whilst providing many advantages, the concept of reusable cores is not without its problems. For small design companies, the acquisition of suitable libraries can be expensive. In the majority of cases these libraries may contain a large number of components, many of which may never be used. Design engineers must be able to justify the cost of the entire library against the proportion of the library they realistically intend to use. IP core solutions also pose problems for the authors. Once a library has been sold, the provider looses direct control of their intellectual property. The provider is then left to trust that any new proprietor will respect and obey the terms and conditions of any licence accompanying the virtual circuit blocks.

In view of the foregoing comments, it can be seen that there is a need for an improved circuit design tool.

As well as an improved tool for circuit design, there is a need for an improved method for generating IPs that are computational representations of real devices for use in IP based design processes. It would be useful if any such improved technique could be used in real time in order to model devices to meet technical specifications input to a circuit design tool.

Consider as an example linear transforms. These are used in a very wide variety of signal processing applications. They are used both in linear systems, and also as component parts; for non-linear systems. Example linear transforms include the Discrete Cosine Transform (DCT), which is often used in image compression, and Finite Impulse Response (FIR) filters, which are extremely widely used for audio, video and data processing. A linear system can be specified by a matrix of coefficients that describe the relationship between the inputs and outputs of a device. Consider also non-linear transforms. These can be used in filtering applications. Non-linear systems tend to be more difficult to design than linear systems. One problem is that the amount of information needed to characterise a non-linear system can be arbitrarily large.

In order to design non-linear systems stochastic search techniques can be used. These techniques are useful for discovering near-optimal solutions to complex problems. They are used when there is no way of discovering a true optimal solution within a reasonable time. Stochastic searches make use of randomness, and so multiple applications to a problem will produce different sets of results. However, there is no guarantee that a search will be successful and it is always possible that a search will produce poor quality results.

Two of the main types of stochastic search are stochastic hill-climbing and Evolutionary Algorithms (EAs). These techniques use an application-specific fitness function to assign a fitness ‘score’ to a solution. The algorithm can then select the best solutions according to the fitness value. Higher fitness values are selected for maximisation problems, and lower values are selected for minimisation problems.

Stochastic hill-climbing is performed as follows. An initial solution to the chosen problem is randomly created. The solution is then iteratively improved. To improve the solution, a randomly modified version of the solution is created. If the modified solution is better than the original solution, then the original solution is replaced, otherwise the modified solution is discarded.

As regards Evolutionary Algorithms, these are a set of optimisation techniques that were inspired by natural evolution. Examples of these are described in the book “Genetic Algorithms in search, optimization, and machine learning” by David E. Goldberg, and published by Addison-Wesley, 1989. Rather than discovering a single solution to a problem, EAs work upon a population of many solutions. An EA starts with an initial population of randomly created solutions. It then iteratively improves those solutions. Each iteration of an EA is known as a generation. The EA creates an improved population of solutions by creating modified versions of existing solutions, and applying selection operators in order to ensure that the best solutions are replicated.

There are two main classes of modifications that and EA can perform on a solution. The first of these is mutation, which involves making a random change to a single solution. The other class of modifications is crossover, which involves combining two solutions to produce a hybrid solution. Selection ensures that the best solutions (according to the fitness measures) are reproduced and that the worst solutions are eliminated. Selection is typically performed probabilistically. The use of a population of solutions ensures that EAs are a robust method of problem solving.

When solving a multi-objective optimisation problem, there will often be more than one optimal solution. Each solution to a multi-objective problem represents a different trade-off between the different objectives. The fact that EAs work with a population of solutions means that they can be usefully applied to multi-objective problems. This is described in the book “Multi-Objective Optimization Using Evolutionary Algorithms” by Kalyanmoy Deb, and published by John Wiley and Sons, 2001. EAs are a well-established multi-objective search technique. The major difference between a single-objective EA and a multi-objective EA is that multi-objective selection methods are usually designed to preserve a variety of solutions to a problem; a multi-objective EA should be able to produce multiple solutions, where each solution strikes a different balance between conflicting objectives.

EAs have been used for a variety of problems relating to electronic circuit creation and optimisation, see for example the following articles: “Real-world applications of analog and digital evolvable hardware,” by T. Higuchi et al, IEEE Transactions on Evolutionary Computation, vol. 3, no. 3, pp. 220-235, September 1999; “Evolving more efficient digital circuits by allowing circuit layout evolution and multi-objective fitness,” by T. Kalganova and J. Miller, in Proceedings of the First NASA/DoD Workshop on Evolvable Hardware, July 1999, pp. 54-63 and “Graph-based evolutionary design of arithmetic circuits,” by D. Chen et al, IEEE Transactions on Evolutionary Computation, vol. 6, no. 1, pp. 86-100, February 2002. However, a weakness of using EAs for circuit design is that, when changing connections in a circuit, there is no reward for finding part of a good solution. Ideally, if changing a connection from wire X to wire Y increases the fitness, it would suggest that wires similar to wire Y are likely to produce further increases in fitness. Unfortunately, there is no concept of ‘similarity’ for connections. If a good choice of connection is found, there is no a way of biasing the search towards other ‘similar’ connections. This limits the ability of EAs to focus in on an optimal solution for circuit design. A further disadvantage of using EAs is that they tend to be relatively slow.

An object of the present invention is to provide an improved design tool.

Another object of the invention is to provide an improved method of modelling and thereby providing a computational representation of circuit components.

According to one aspect of the present invention, there is provided a system for designing circuits, the system comprising a controller that is adapted to communicate with a plurality of user terminals and is configured to maintain a plurality of user selectable computational representations of electronic components or devices; receive from a user terminal a user selection of one of the components or devices; send a signal to the user terminal for causing a symbol representative of the selected component or device to be generated by the user terminal; receive a symbol based design from the user terminal; use the symbols to identify the selected components or devices to create a computational representation of the circuit in accordance with the symbol based design.

By computational representation, it is meant a detailed representation of a circuit and/or component that identifies its specification, including such features as its input and output characteristics and other performance criteria. In particular, the computational representation may be an IP core. In contrast, each symbol that is generated at the user terminal is merely a graphical or pictorial representation of the selected component. The specific details and specifications of the selected components are not downloaded to the user terminal as the design process progresses. This means that a relatively low level of data is transferred between the controller and the user terminal, so that the design process is relatively fast and flexible. It also means that the user does not have direct access to the specific design of particular components, which means that the integrity of the design of the components can be more easily maintained and controlled. This in turn means that the proprietor of such designs can more readily control revenue streams derived from the licensing thereof.

The controller may be configured to receive a user-defined characteristic; determine components or devices having that characteristic and provide one or more user selectable identifiers associated with each of the components or devices found.

The user selectable representation of the electronic component or device may be an identifier associated with a pre-verified hardware core module, for example an IP core, for implementing that component or device.

The controller may be adapted to provide documentation on a selected component or device in response to a request from the user terminal. The documentation could include any one or more of the following: a text description of the device; device functionality; possible uses; customisation potential; limitations; physical attributes; I/O ports, and performance parameters, at least.

According to another aspect of the present invention, there is provided a method for designing circuits, the method comprising maintaining a plurality of user selectable representations of electronic components or devices; receiving from a user terminal a user selection of one of the components or devices; sending a signal to the user terminal for causing a symbol representative of the selected device to be generated; receiving a symbol based design from the user terminal; using the symbols in the design to identify the selected components or devices and creating a circuit representing the symbol based design.

The method may further involve receiving a user-defined characteristic; determining components or devices having that characteristic and providing one or more user selectable identifiers associated with each of the components or devices found.

The user selectable representation of the electronic component or device may be an identifier associated with a pre-verified hardware core module for implementing that component or device.

According to yet another aspect of the present invention, there is provided a computer program, preferably on a data carrier or computer readable medium, for use in conjunction or association with a store or memory that includes a plurality of user selectable representations of electronic components or devices, the computer program having code or instructions for: receiving from a user terminal a user selection of one of the components or devices; sending a signal to the user terminal for causing a symbol representative of the selected device to be generated; receiving a symbol based design from the user terminal; and using the symbols to identify the selected components or devices and creating a circuit representing the symbol based design.

According to a further aspect of the invention, there is provided a user terminal that is adapted to: present a plurality of user selectable electronic components or devices; receive a user selection of one of the components or devices; send a signal to a remote controller indicative of the user selection; receive from the controller a signal or interface associated with the selected component or device, and generate in response to the signal or interface received from the controller a symbol representative of the selected component.

According to a still further aspect of the invention, there is provided a computer program, preferably on a data carrier or computer readable medium, the computer program having code or instructions being adapted to: present to a user a plurality of user selectable electronic components or devices; receive a user selection of one of the components or devices; send a signal to a remote controller indicative of the user selection; receive from the controller a signal or interface associated with the selected component or device, and generate in response to the signal or interface received from the controller a symbol representative of the selected component.

According to a still further aspect of the present invention, there is provided a computational circuit that is the product of any one of the methods or systems or computer programs of the previous aspects of the invention.

According to yet still another aspect of the invention, there is provided a device or circuit that is made according to a design devised using the controller and/or method and/or computer program defined in the preceding aspects of the invention.

According to a further aspect of the invention, there is provided a method for designing a computational device or circuit having one or more desired characteristics, preferably input and/or output characteristics. The method involves using an inner, iterative search that is preferably used within one or more genetic operators. As a first step, one of a population of computational circuits or devices is selected. Once this is done, a point in the selected circuit or device is chosen and characterised in terms of the circuit input(s) and/or output(s). The characterisation with respect to the inputs describes the components that connect the device or circuit inputs to the point. The characterisation with respect to the outputs describes how the value of the point alters the values at the device or circuit outputs. All other parts of the circuit independent of the selected point are also characterised. These characterisations can be combined to provide an overall device characterisation. The parameter or characteristic associated with the selected point is then modified and the point is re-characterised. This is repeated to provide characterisations for a plurality of modified versions of the circuit. The circuit that has characteristics closest to the desired characteristics is identified using the characterisations for the selected and modified points and the characterisation of the rest of the circuit independent of the selected point. The best circuit is then added to the population and the inner search loop is repeated for another one of the population. At the same time, an outer search, preferably within an evolutionary algorithm, is used to iteratively search the population to determine the circuits or devices having characteristics that are closest to the desired characteristics. It should be noted that whilst this method is described as for designing a computational device or circuit, it will be appreciated that the device or circuit could of course be a sub-part in a larger design or circuit.

The method for designing a computational device in which the invention is embodied nests a relatively fast but unreliable search within relatively slow, but generally reliable search to provide a means for achieving a fast, but reliable search. The method provides a two level optimisation process. It uses an initial population of possible circuits. One of these is then selected and modifications are identified. The effect of these modifications on the circuit characteristics is determined so that the best, modified circuit can be identified. This modified circuit is then added to the population of possible circuits. This is one level of the process. This is repeated for other types of modifications to provide other modified circuits, each of these modified circuits being at least partially optimised and added to the population. At the same time, on another level an iterative search is done to determine which of the circuits within the population have characteristics that are closest to the desired characteristics. Good circuits are retained and poorer circuits are removed, so that the quality of circuits in the population is continuously being improved. By providing a two level process of this nature, the search time for identifying an optimum computational device can be greatly reduced.

The inner search may be used within one or more genetic operators. The genetic operator may be operable to use heuristic techniques to modify circuits. A heuristic solution to a problem typically involves making many small, positive changes to a solution. Small parts of the solution are improved, so that the overall quality of the solution also tends to increase.

The device or circuit may be represented by Directed Acyclic Graphs (DAGs). These graphs have nodes that correspond to computational components, and edges that correspond to the interconnections between components. The method may use a population of graphs. The graphs in the initial population can be trivial. The graphs in the initial population can be randomly generated. One or more types of genetic operator may be used to create modified versions of the graphs present in the population. The genetic operators may be operable to alter the value on an edge such that it is closer to the ‘ideal’ value. One or more of the genetic operators may be operable to perform a local search when choosing which modification to make to a design. The genetic operators may be operable to perform tasks such as, but not limited to: choosing the best source for an edge; inserting a node that performs addition onto an edge, and choosing the best input value for the addition; and choosing the best scale factor for a node that performs scaling. The genetic operators may be operable to perform searches that can either be exhaustive searches or partial searches.

The method may further involve characterising the properties of the device or circuit and comparing the characterised properties to a specification. Where a graphical representation is used, the properties of each point, for example an edge or node, in a graph can also be characterised. The characterisation for an edge may include information describing the way that the value present at that point in the graph relates to the values at each of the inputs to the design. The characterisation for an edge may include information describing the way that the value at that point in the graph influences the values on each of the outputs of the design. Preferably, the method involves identifying an ‘ideal’ value for an edge; this is the combination of input values, which, if present on that edge, would best minimise the difference between the design's performance and the specification. The ‘ideal’ value for an edge can be derived from the relationship between the edge and the device outputs.

The method may further involve deriving one or more fitness measures from the properties of a design; a fitness value being a numeric measure of the ‘usefulness’ of particular design. One of the fitness measures may correspond to the deviation between the response of a design and the specification. Hence, it is a measure of how well the design functions. Optionally, there may also be other fitness measures, including, but not limited to, the number of components used in a design, and the speed at which a design can operate. The or each fitness measure may be used in the step of assessing or searching, thereby to identify the circuits or devices that have the characteristics that are closest to the desired characteristics.

The method may further involve using selection operators to encourage the survival, reproduction, and modification of designs that perform well (according to the fitness measures), and the elimination of designs that perform poorly.

The desired specification, device characterisation, and edge characterisation, can optionally include constant terms; these can be used in the design of devices that require the addition or subtraction of constant values.

The desired specification, device characterisation, and edge characterisation, can optionally include terms relating to second-order and higher-order polynomials of the inputs. This enables the description of non-linear devices.

In order for non-linear designs to be created, one or more genetic operators may be provided for the insertion of non-linear components. These components may include, but are not limited to multiplicative components; a component that outputs whichever of two output values is largest; Boolean components such as ANDs, ORs and NOTs, and mathematical functions such as sines, cosines, logarithms, exponents, etc. The insertion of non-linear components could either be done heuristically or non-heuristically.

The method may further involve providing graph nodes for performing multiplication or other non-linear operations. This too enables the creation of non-linear devices.

For implementing a linear device, the design may be characterised as follows:
R=b·a^{T}+C
where R is an m×n matrix containing the response of the design; a^{T} is an array of coefficients that characterises the relationship between a specific edge and the circuit inputs; b is an array of coefficients that characterises the relationship between the specific edge and the circuit outputs, and C is an m×n matrix containing the response of a section of the design that is independent of the edge. By using this characterisation, most of the time only part of the circuit needs to be modelled, that is the part connecting a node to the output, and the characterisation information allows for the rapid modelling of this section of the design.

Various aspects of the invention will now be described by way of example only and with reference to the accompanying drawings, of which:

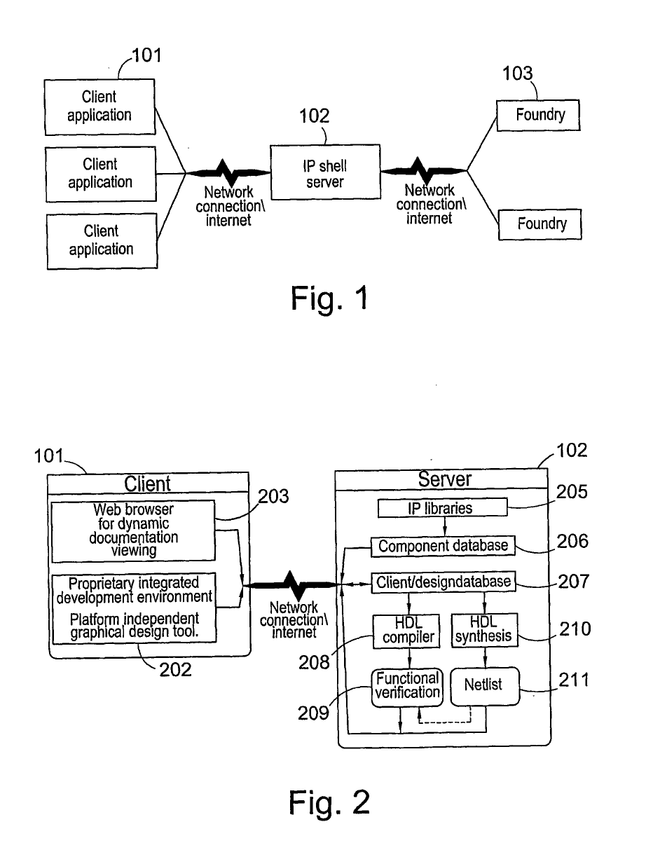

FIG. 1 is a block diagram of a system for designing circuits;

FIG. 2 is a more detailed block diagram of the system of FIG. 1;

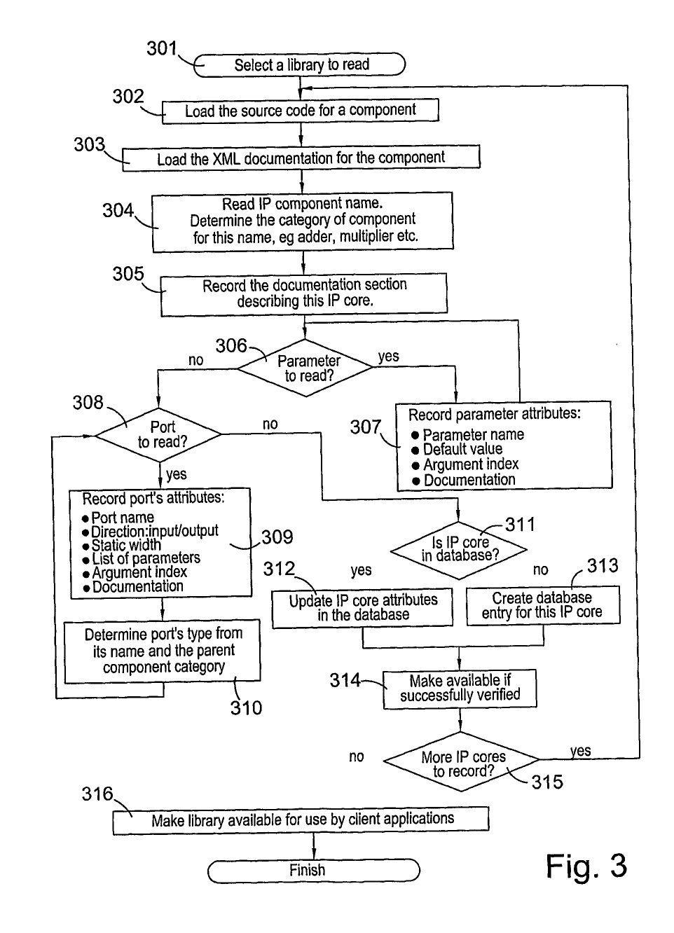

FIG. 3 is a flow chart detailing the set up of an IP library in the server-side database of FIG. 2;

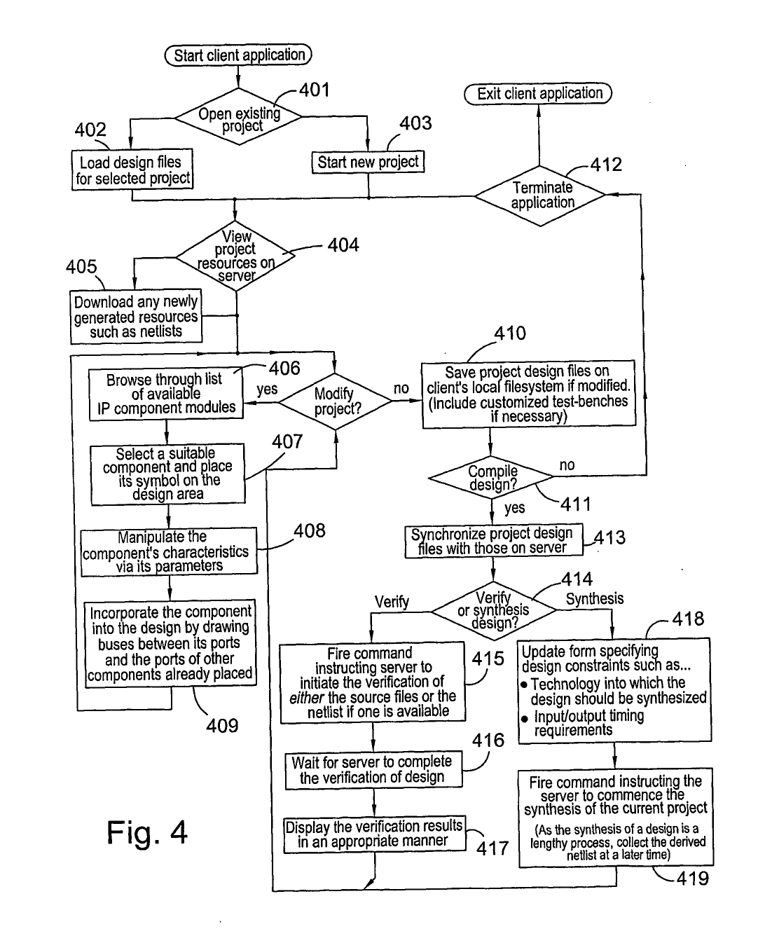

FIG. 4 is a flow diagram of the overall design process as experienced by a user;

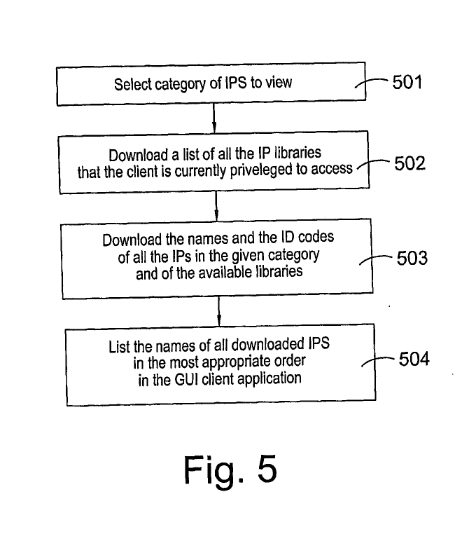

FIG. 5 is a simplified flow chart of the process for allowing a client to visualise all the IPs of a designated category in the libraries to which they have access privileges;

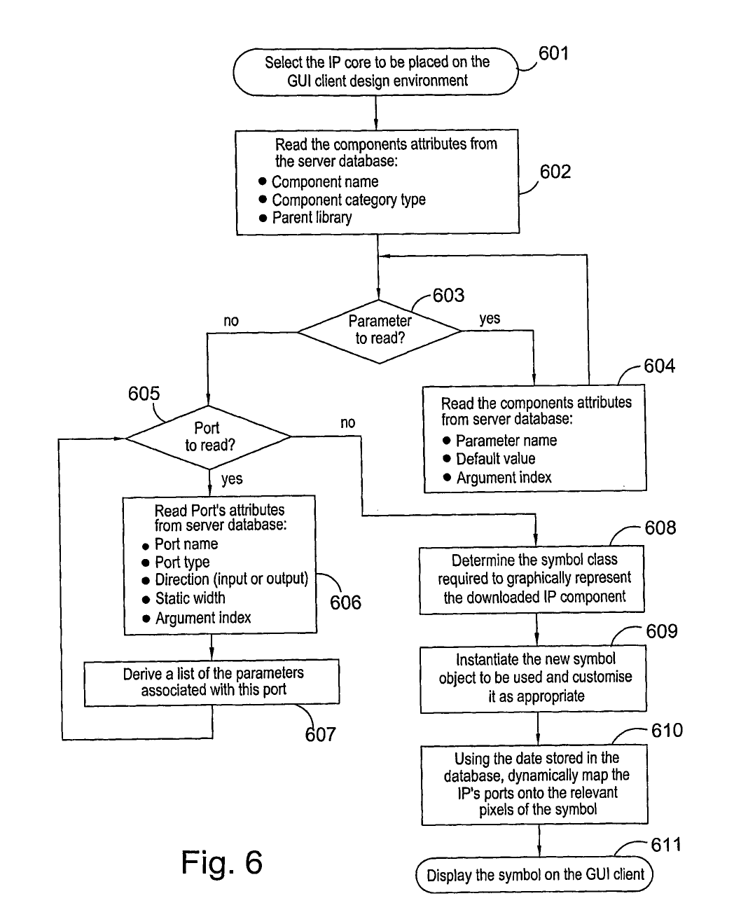

FIG. 6 is a flow diagram of the steps taken when an IP core is selected by a user;

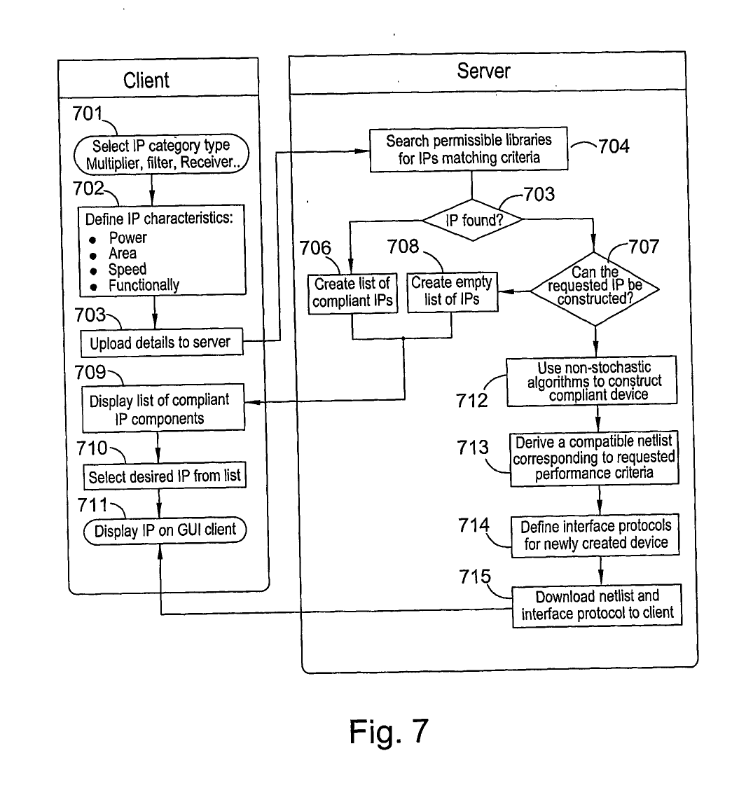

FIG. 7 is a diagrammatic representation of a search engine for finding IP cores having defined traits;

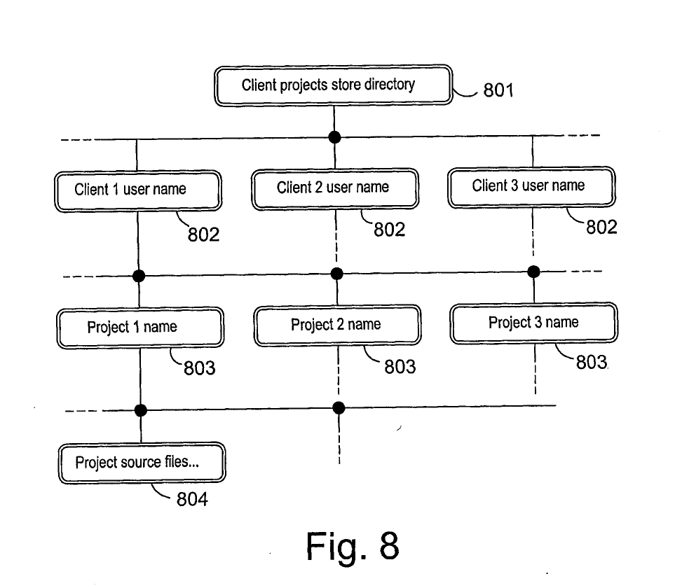

FIG. 8 is a diagrammatic representation of the structure of a server side client store directory;

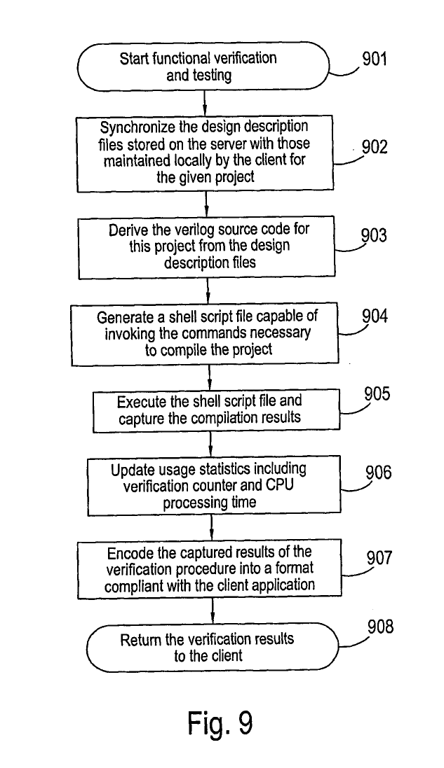

FIG. 9 is a flow diagram of a verification process;

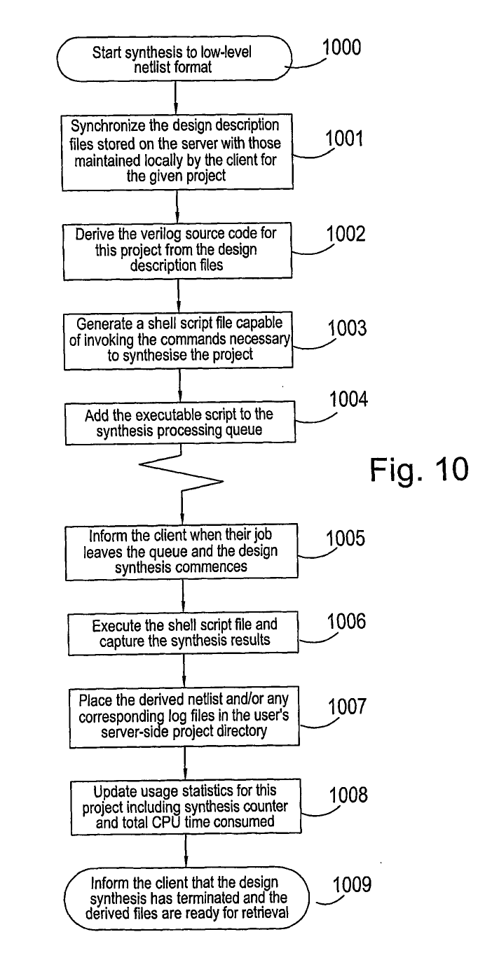

FIG. 10 is a flow diagram of a synthesis process;

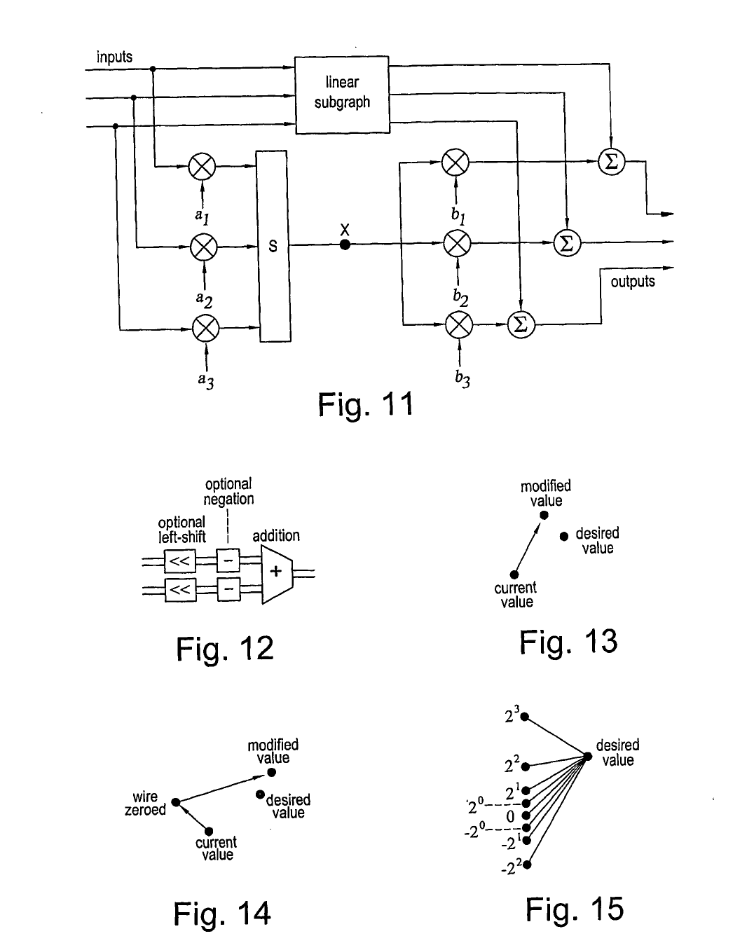

FIG. 11 is a schematic view of a model of a circuit;

FIG. 12 is a representation of a single node in the circuit of FIG. 11;

FIG. 13 illustrates the modification of circuit values in order to optimise them towards a desired value;

FIG. 14 shows how circuit values can be altered by zeroing wires;

FIG. 15 shows how a shift-changing operator uses hill-climbing to find a scale factor that is closest to the ideal factor;

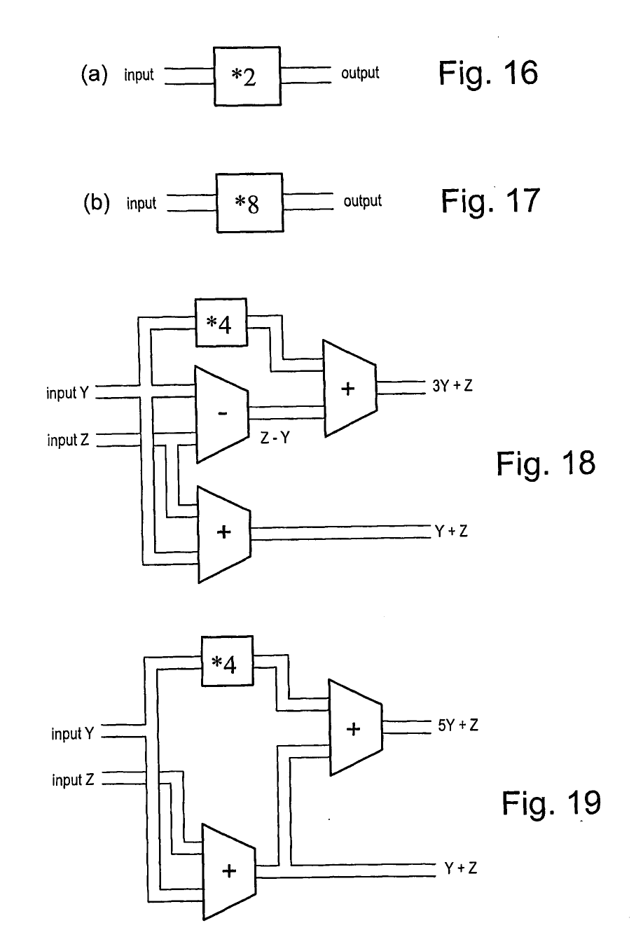

FIG. 16 is a block diagram of a simple circuit;

FIG. 17 is a block diagram of a modified version of the circuit of FIG. 16;

FIG. 18 is a block diagram of a more complex circuit, and

FIG. 19 is a block diagram of a modified version of the circuit of FIG. 18.

FIG. 1 depicts a multi-tier approach to circuit design whereby multiple clients can be simultaneously supported by a comprehensive IP shell server application. Included at the client side is a client application 101 for establishing a connection with the IP shell server 102. Of course, the connection to the IP shell server 102 could be provided over any other suitable type of network, such as an intranet. The server side maintains libraries of IP cores, and a database describing their interface protocols. By IP core, in this context it is meant, typically, a silicon design with a complexity ranging from one thousand to one million gates. Usually the IP cores are referred to as complete functional units, which could independently perform a desired task. Examples of IP cores include filter circuits, receiver circuits and transmitter circuits. Each IP is made up of macro components, which are sub-blocks, such as adders, multiplexers, multipliers and memory components. The server 102 is also responsible for compilation and synthesis of any client design and ultimately providing a netlist, or any other information suitable for use by a foundry, compatible with a design engineer's specifications. The server 102 may also be operable to establish a connection over, for example, the internet with a design foundry 103, so that once a design is finalised, it can be passed directly to the foundry 103 for fabrication.

FIG. 2 shows the client side 101 and the IP shell server 102 in more detail. Included at the client side 101 is a thin client integrated circuit development environment 101 that has a standard web browser 203 for providing access to an interactive tool 202 that has an integrated development environment and a platform independent graphical design tool. Included at the IP server 102 is an IL server application for using and maintaining various IP libraries 205 and associated component databases 206, as well as a client design database 207, which includes details of all authorised or registered users. Also provided is an HDL compiler 208 for compiling code for circuits designed by the client, an HDL synthesis module 210 for synthesising the functional description of the circuit into a specific implementation, a functional verification module 209 for verifying that particular components are compatible and a netlist module 211 for generating a netlist that describes the specific connectivity of the components. These modules will be described in more detail later.

To access the design functionality, each client has to register with the IP server. Mechanisms for doing this are well known and so will not be described herein in detail. Once registered, a client is provided with the thin-client IC development environment 101. This is adapted to allow the user to graphically design products using the interactive tool 202 based purely on IP cores maintained on the server 102. The server 102 maintains an array of application specific libraries 205 that clients can register to use. Example library applications may include audio, video, communications etc. The client application appears to have dynamic access to the server-side IP libraries 205 that they have permission to use via the intermediary component catalogue 206. Hence, as new components are added to each library, all clients 101 have immediate access to them.

Each library on the server 102 is comprised of a range of IP domain frameworks tailored to a particular application area, such as audio, video etc. The constituents of each framework include highly optimised IP cores and macro-IP cores. By macro-IP (mIP) cores it is meant a flexible set of subcomponents used in building IPs and systems on a plug-in basis. Typical mIPs may include filters, FFT blocks, multiply-accumulate units, dedicated RAM and ROM units, optimised datapath and multiplexing schemes etc. Certain IPs may also include on-chip controllers and SoC interface wrappers. The mIPs are optimised with a high fault coverage and are both technology and tool independent making them ideal building blocks for the rapid development of complete System-on-Chip (SoC) devices. As well as mIPs, the framework constituents may also include appropriate test benches, documentation and in certain cases, Built-In-Self-Test (BIST) modules for critical cores such as RAM, datapath and multiply-accumulate units.

Each IP or mIP module maintained on the server is accompanied by extensive documentation. The documentation for each IP core is fragmented into well-defined constituent parts. Each section of the documentation is dedicated to a particular facet of the component such as description, functionality, possible uses, customisation potential, limitations etc. Additionally, the physical attributes of each device are independently transcribed. Every I/O port attributed to a component has a separate section in the documentation. Likewise, parameters belonging to a component are separately documented. The physical structure of the documentation is defined using XML (extensible mark-up language) using metatags to define the subdivisions. In such a format, the documentation for any given IP may be made available in a variety of forms.

The documentation on each IP or mIP is dynamically accessible to the client via a live network link such as the internet. The documentation could be streamed to the client application on request or presented in a web browser 203 using dynamic HTML. Additionally, the documentation could be presented in full or in part. For example, an inquisitor may only require information regarding the customisation of an IP via one of its parameters. In such a case, information exclusive to that parameter alone could be provided.

Associated with each IP or mIP is an interface that uniquely identifies it. By way of various interactive graphical component selection screens, such as drop down menus or other means for presenting user selectable identifiers, the client can choose to download the ‘interface’ to the core that they wish to embed in their design. Once the component interface is downloaded to the client terminal, a graphical symbol representing that component is dynamically generated by the client application and displayed in the design environment. Some characteristics and parameters of that component can then be modified appropriately through its symbol. This will be described in more detail later.

As many components as necessary to complete the design can be downloaded from the server to the client terminal. The symbols representing the components can be connected and manipulated as in any other CAD integrated development environment (IDE). Alternatively, the client may require only a single, highly complex IP core such as a digital signal processor (DSP) optimised for a particular application. It is important to note that in contrast to existing systems, only interfaces or identifiers representing selected IP cores are downloaded. The actual IP's do not leave the server and the symbols presented to the user are dynamically generated by the client application.

Once completed, details of all the ILs and/or mIPs used, as well as how they are connected to each other, are sent to the IP server 102. The design is then compiled by the server application 208. The client GUI may provide an optional stimulus for the design to assess the functional attributes of the framework at this stage. For example, the GUI may allow the user to select a “functional verification” option from a drop down menu. If this is selected, a signal is sent to the functional verification module 209 in the server 102 to cause it to carry out a verification analysis on the design. Once completed, the results of this verification could be displayed by the client application. At this stage, the client application may be operable to allow the user to make changes to the design, if necessary.

Alternatively or additionally, once the design is completed, the client may choose to run one or more test-benches available on the server. To enable this, the GUI may allow the user to select a “test” option from a drop down menu. If this is selected, a signal is sent to a test module in the server 102 to cause it to carry out a verification analysis on the design. Once completed, the results of this verification could be displayed by the client application. At this stage, the client application may be operable to allow the user to make changes to the design, if necessary.

When the designer is satisfied with the design, a command is sent to the synthesis module 210 in the IP server 102 instructing it to synthesise the design for the chosen silicon technology. This process generates a netlist 211, which identifies all of the components of the circuit and describes specific component connectivity. The netlist 211 may then be returned to the client application, or alternatively may be sent directly to a foundry 103, so that the design can be fabricated.

The arrangement described above provides a relatively simple, lightweight but fully comprehensive platform independent development environment. Hence, the problem of installing and maintaining a complicated design environment is avoided. In addition, using the catalogue interface, a vast range of pre-verified IPs can be made available for use in the target application for which a client may be registered. Such a proposition also protects the IP developers, because clients never actually have the IP cores in their possession. Ultimately, the coalition of high performance IPs and an easy-to-use design environment significantly reduces both the design and verification cycles and ensures fast time to market.

The enhanced design automation tool in which the invention is embodied will now be described in more detail, with reference to FIGS. 3 to 10.

FIG. 3 is a flow-chart illustrating a process for constructing a server-side database suitable for providing all information regarding IP's required to support the proprietary client design environment. The server file structure may be organized such that there are multiple repositories of IP cores, each of which are referred to as libraries 205. Each library may be dedicated to housing IPs relating to a particular target application, such as audio, video, communications etc. The first step 301 is to select the library to be catalogued in the database. Subsequent to library selection, the source code for each IP in that library must be parsed and the relevant attributes extracted and applied to the database 302-313. This involves firstly loading an IP's source code in preparation for parsing 302. In addition to its source file(s) an IP module may also have associated documentation in the form of an XML archive. If available, this too is loaded and parsed appropriately 303. Each documentation file contains detailed information relating to the attributes of the IP module, such as its intended use, characteristics and possible limitations. Additionally, the traits of each individual port belonging to the core may also be inscribed in the documentation file. Relevant port attributes may include the function of the I/O and parameterisation potential. Reinforcing the comprehensive information regarding the physical characteristics of the device is knowledge detailing its parametrics. Each parameter may be characterized describing the physical adaptations incurred through modifying their values and the consequences of any alterations. Incorporating the documentation into the server database allows it to be accessed in a variety of ways. If requested, the client application can dynamically download the documentation for a-particular IP if necessary. Alternatively, details regarding each IP can be dynamically streamed onto a web page using the most appropriate internet technology, such as PHP, JSP or ASP. Such an approach means that the most up-to-date documentation for each IP is always available.

Having loaded the appropriate files, parsing can commence. The initial task 304 is to determine the type of component currently being analysed. This can be done by isolating the name of the primary module in the source file and then, via a look-up table of regular expressions determine the corresponding component type, such as multiplier, shift register etc. If the module has any parameters associated with it 306, they too must be recorded into the database 307. The necessary attributes of parameters include their names and default value. As the order in which parameters occur in the instantiation of the module is important, the argument index, which is a number that is indicative of a position in an ordered list, of each parameter must be recorded. Finally the documentation sourced from the XML file 303 corresponding to the parameter in question is recorded. Subsequently each port belonging to the component 308 is analysed, its attributes recorded 309, and the type of port determined 310.

Indispensable traits of a port include its name, whether it is an input, output or in/out, its static width and a list of associated parameters. In the majority of cases ports are of a fixed width herein referred to as the static width. However, in certain cases the width of a port can be configured prior to compilation/synthesis using one or more parameter variables. Under these circumstances, a list of all applicable parameters and the associated expressions linking them must be maintained. Similar to parameters, the order of occurrence of ports in the module's instantiation is important, hence the argument index of each port must be recorded. Again the documentation associated with each given port can optionally be stored such that it can later be dynamically referenced.

As the information in the database is ultimately to be used to display dynamically generated symbols, the type of each port must be established 310 and recorded. In addition to the list of component categories, the database also maintains a register of all possible types of ports attributable to each component. Using regular expression pattern matching based on the port names, the individual ports of an IP can be classified into their corresponding type groups.

Up until this point all information regarding the interfacing protocols parsed from the HDL source code of a given IP will be cached in a model object. This model object is specifically crafted to house all relevant attributes of IP interfacing in the given context. By object, it is meant a building block component of a piece of software in an object oriented programming language such as Java. Such a model object encapsulates the structure of the interface, parameterisation capabilities and port properties. Once the model's characteristics have been registered, a verification stage may be employed to ensure the validity and integrity of the model. Possible violations include general parsing errata and the inability to categorise the IP module or any of its ports. In such a scenario, an engineer may be alerted to take the appropriate corrective action. Assuming that all is well the IP will be appropriately registered in persistent storage. The act of committing an IP to storage depends upon whether the given module already exists on the server. If so, the database entries are simply updated to reflect any potential changes. Otherwise, a new entity object will be instantiated on the application server mapping the characteristics of the new component into the relevant tables of the underlying database.

The above-mentioned steps are repeated as many times as is necessary 315 to ensure that every IP in the designated library is parsed and applied to the database. Subsequent to renovating the database, a flag can be set indicating the availability status of that particular library to the client applications. Additionally, by setting this flag to false at a later stage-access to it by all client applications can be prevented.

FIG. 4 depicts an approximation of the stages in the design flow from the perspective of the client. As mentioned previously, the client application is operable to implement a graphical user interface for presenting information from the IP server to the user and receiving inputs from the user. Initially, the client is presented with the choice of starting a new project or opening an existing one 401. Any previously created project is located on the client's own local file system and loaded 402, so that its content can be viewed and, if desired, manipulated. If there is no existing project, then a new project is started 403. After opening a project, the client can access the IP server 102 to determine what resources belonging to that particular project are stored there 404. If the client were starting a new project design, the list of resources would be empty. An example of a server resource may be a netlist. As the production of a netlist is a lengthy process, the client may have previously initiated a synthesis sequence by sending an appropriate request to the synthesis module in the server 102 before shutting down. The new resources associated with the netlist may be downloaded 405. This facility allows the client the opportunity to retrieve any netlists generated on the server while the client machine was off.

Subsequently, the client may enter the IP design loop. At this stage, the GUI is operable to present symbols that represent IP or mIP cores stored on the server 102. The symbols can be drag and drop symbols, which can be dragged and dropped by the user and interconnected using bus symbols. The user can browse through the available IL cores 406 and select desired components 407. For each component that is selected, a signal is sent to the server 102, which recognises it as a request for a component. The server then returns the interface for the component selected. Receipt of the interface at the client application causes that application to generate a symbol representing the selected component and place it in the design area of the GUI. Characteristics of the components can be manipulated by allowing the user to change the list of parameters. This will be described in more detail later with reference to FIG. 6. The component is then incorporated into the design 409 by drawing buses between the symbols ports and the ports of other components already included in the design. When the design schematic satisfactorily reflects the client's intended application, it is saved to the client's local file system 410. At this point the client has the opportunity to include their own customized test bench with the project. This allows them to ensure that the produced design complies with their original specifications. Means for implementing test benches are well known and so will not be described herein.

Once the design is saved, the GUI provides the user with the option to compile the design 411. If the user does not wish to compile at this stage, the application is terminated 412. If the user opts to compile, then the project design files saved in the client file location are synchronised with those on the server 413, to ensure that the server version of the design in up-to date. Once this is done, a prompt is generated by the GUI asking the user to indicate whether they want to verify or synthesise the design 414.

When the “verify” option is selected, a fire command is generated by the client application to instruct the server to initiate the verification of either the source files or the netlist files, if available 415. Then, it is necessary to wait for the server to complete the verification process. Once this is done, the verification results are displayed in an appropriate manner.

When the “synthesise” option is selected, the user is prompted to enter design constraints, such as the technology into which the design is to be synthesised and input/output timing requirements 418. A fire command instructing the server to commence the synthesis of the current project is then sent to the synthesis module of the server to commence synthesis of the current project 419. Because synthesis of a design is a lengthy project, the netlist that is the result may be stored on the server for collection by the user at a later time.

FIG. 5 is a flow chart depicting a possible route to visualisation of all employable IPs in the libraries available to a client. Initially the client selects a category 501 of IPs to list. An example of a possible category could be “subtractor”. The application then queries the catalogue 502 requesting a list of all the libraries that the client has access to. Subsequently 503, a list is compiled of all the IPs of the designated category, in the above example a subtractor, in all accessible libraries. The server then communicates the names and ID codes of all available IF components to the client. Utilising the most appropriate graphical display technologies 504, the list of all procurable IPs is presented on the client, allowing the logged in user to select the one they wish to download.

FIG. 6 shows the steps that are taken to download a selected component. Once the desired core has been selected, its interface must be downloaded and the appropriate symbol dynamically generated and displayed 602-611. Using the ID code of the chosen core, the characteristics of its interfacing protocols are acquired by the client 602. This involves ascertaining the IP's name, category type and the library of which it is a member. In the event of there being one or more parameters affiliated with the IE 603, their relevant attributes are acquired from the server database 604. The attributes could include the parameter name, for example the width of the address port, that is the number of input pins, a default value and an argument index Subsequently each port 605 belonging to the IP is configured in the client, based on the knowledge available on the server 606. Essentially the necessary attributes are secured and cached, the attributes including port name, port type, whether they are inputs, outputs or in/outs, the static width and argument index. Assuming that a port is parameterisable 607, a list of the previously sourced parameters is dynamically constructed in the form of a mathematical expression. Manipulation of this expression can then allow for dynamic configuration of a port's width at any time after the IP has been instantiated on the client design console.

After downloading a component's interface attributes, a symbol for use on the GUI is dynamically generated by the client application. Based on an IP's category type, a library of classes is scanned in a quest to isolate one of corresponding type 608. Once identified, that class is instantiated 609 using the data acquired from the server. In the instantiation procedure, the class is customised as appropriate setting attributes such as name and configuring the parameters and ports. As part of the instantiation procedure, the ports need to be mapped to the relevant active regions of the symbol. The class defining a symbol is endowed with the knowledge as to the relative positions of the various types of ports. Each port is then dynamically linked as an active icon on the symbol 610.

It should be noted that in many cases the exact outline of a symbol is dependent upon the number of ports that it has. For example some types of components such as subtractors have a fixed number of ports and thus a static shape. Other components, such as multiplexers that have an arbitrary number of inputs, produce a silhouette defined by the number of ports. Hence the contours of a symbol are dynamically spawned in response to the individual circumstances presented. The symbols usually represent the generic shape of the component or circuit as well as showing the number of input ports specified. Finally, a graphical representation of the requested component is displayed in the client design environment. In this way, a dynamically customisable symbol is created on the client development tool to graphically represent the selected IP core. Further tailoring of the component may then be performed using techniques similar to those employed in other integrated circuit design environments.

In a typical scenario, the client may request information relating to a particular device they are considering utilising in their current design. From the list of IPs procurable to the client in question, the solicited information regarding the nature of that device could be dynamically streamed to them in a manner most appropriate to the situation. Alternatively, after embedding an IP in their design using the proprietary IDES the client may wish to explore the customisation potential of the device via one or more of its parameters. Via the GUI environment the documentation pertaining to the parameters in question could be dynamically streamed to the IDE. Furthermore, any available documentation may be dynamically translated into HTML and accessible on the web via a standard web browser. In all cases, the documentation is dynamically served to the client either in the IDE or on a web page. Hence, no caching of documentation is performed by the client application resulting in stagnant information. Each time the client wishes to view any section of the documentation, a new request is posted to the server. This means that the latest information relating to the IPs is always presented.

In the foregoing description, it is assumed that the designer selects an IP from, for example, a list. This, however, means that the user has to know or investigate the parameters associated with particular components. To optimise the design process, a search engine is provided to allow a user to search for components having particular characteristics. FIG. 7 illustrates a possible search engine for allowing a client to pursue an IP of particular characteristics. Initially, the client selects the type of component they require to embed in their design 701. Possible category groups ideally suited to this application include the likes of multipliers, filters, receivers etc. Such components, which are of moderate to high complexity, can be optimised to promote particular attributes such as for example power and/or area. If the category type selected by the user is searchable by attributes, a window may be presented to the user allowing them to specify their desired traits 702. The nature of the window depends upon the category type. For example, a prospective list of searchable attributes for an FIR filter may include power, area and accuracy/signal to noise ratio.

After registering the desired characteristics, the server-side component database is queried 704 for possible matches. Assuming that one or more eligible candidates have been identified 705, a suitably formatted list 706 is generated and returned to the client 709. The client can then subsequently select their desired component from the list 709 and display it 711 for manipulation as with any other component. If however a compliant device could not be identified in the database 705, the server application attempts to determine if the IP can be constructed 707. Using a selection of non-stochastic algorithms, the server application may be able to assemble certain types of IP 712 from components available in the permissible libraries in real-time. This will be described in more detail later. If the requested IP type can be successfully forged, its corresponding netlist 713 and interface protocol 714 are defined. Once these parameters are defined, the newly available IP is then downloaded 715 to the client and graphically portrayed 711 in an appropriate manner. In the event that a compliant device could not be constructed 707, an empty list 708 is returned to the client. It should be noted that the attributes used in the search may only be approximate, due to the inherent limitations of the invoked modelling techniques.

When the client perceives that the design is satisfactory and complete, the functionality of it can be verified. Alternatively, the design can be synthesised directly into a netlist. Before either of these stages can take place, the client must synchronize its design files with those stored on the server. For the server to do its tasks, it must have a local copy of the files. Synchronization involves copying any new files to the server, updating any that already exist and deleting any that have been removed from the project.

To synthesis a design, the client may need to complete a form specifying the constraints of the design. Typical constraints include the choice of a technology library to be used from a list of those available on the server and various timing attributes. Once the constraints are accepted by the server a command is sent to initiate the synthesis procedure. As synthesis is a lengthy process, the client is returned to the design interface and is informed later when the netlist is built. Techniques for synthesising designs are well known and so will not be described herein.

To verify a design, the client may have to make the choice of either verifying the RTL verilog sources or the synthesized netlist if one is available. Subsequently the appropriate command is sent to the server and verification begins. Traditionally verification is relatively fast taking from just a few seconds to several minutes. During this time the client is requested to wait. Upon completion of the verification sequences, the derived results are presented to the client in an appropriate format.

FIG. 8 depicts the portion of the server file system that is reserved for a client's IP designs. Although the client maintains the design files corresponding to their project on their own file system, the server needs a local copy upon which to perform verification and synthesis. The top node 801 in the tree structure is the root node for the client's user_space. Under this lies a separate directory 802 for each individual registered user. The name of each user directory directly corresponds to their login username. In each individual users space is a subdirectory 803 for each of their active projects. Each project directory 803 contains all files 804 necessary for the particular IP design. Typically the client application uploads a group of XML files describing that particular design, and possibly some stimulus and corresponding data files. When the client requests that a design be verified or synthesised, the relevant script files are generated from the XML representations and written to this directory. Any results derived from the execution of the script are then written to this directory and can be retrieved at the client's discretion.

FIG. 9 illustrates a single thread of events during the verification of a client's IP design. Initially, the verification process is started 901 and the design files for the given project are synchronized between the client and the server 902. During the design phase on the client, the original files are stored locally by the client. However for the server to perform the verification process, the server itself must maintain a local copy of the design files. Rather than sending the verilog source code, the client may decide to send an XML description of the design instead. In this case, the server needs to derive the verilog sources from the XML design description files 903. In all cases, the shell script required to perform the verification (and synthesis) is dynamically constructed on the server 904. This approach is taken for reasons of security. Obviously it is highly undesirable for the client to send an executable file to the live server. Once the shell script has been successfully fabricated, it is run as a child process to this thread on the server 905. Optionally, the system usage statistics are then up-dated to record the number of times that the verification procedure has been carried out, as well as the processing time used 906. The results of the verification process are then captured and encoded into a format compliant with the client application 907. The results are then returned to the client 908.

FIG. 10 is a flow chart depicting a single thread of execution on the server during the synthesis of a client's design. Steps 1000 to 1003 of the synthesis process are similar to the corresponding steps of the verification process. When all source and script files for a given design are prepared, the top-level script is placed in a processing queue 1004. Each design in the queue is assigned to a processor in a sequential fashion when one becomes available. Optionally, the server may be adapted to notify the client that the synthesis of their design has started 1005. The synthesis module then executes the shell script file and captures the synthesis results to provide a netlist. The derived netlist is then placed in the user's server side directory 802.

Depending upon the complexity of the circuit design, the synthesis may take several hours to complete. Upon successful synthesis of the design, a technology specific netlist is produced. The client may then be informed of the completion of the process, so that the necessary files can be retrieved 1009. As an additional feature, a log is maintained recording the total accumulated CPU time consumed during each synthesis run for that particular project 1008. This may be used when determining the bill for a given IP project design.

As well as providing an improved design tool, the present invention provides new and improved techniques for generating computational devices based on input criteria specified by the designer. These new techniques can be used to generate designs for linear computational devices as well as non-linear computational devices and are based around the combination of a stochastic search technique and a set of heuristic operators. Typically, software based in the IP shell server is used to receive desired characteristics entered by a user and generate a computational device having those characteristics. Of course, the software could be included in another server or computer based system that can be accessed by the IP shell server.

The new methodology for creating combinatorial circuits can be used to create both-linear and non-linear circuits. For linear circuits, hardware designs for transformations are created in the following form: o=Ri, where i is an n element input vector, o is an m element output vector, and R is the m×n response matrix of the device. The number of inputs, n, and the number of outputs, m, are defined by the user of the system. The contents of the response matrix R are user defined. When these techniques are used in conjunction with the tool previously described, the inputs and outputs would be input in the GUI and sent to the server, where they would be used to determine a new optimised device.

For linear designs, the only operations that are used are addition, negation, subtraction, and multiplication by a constant. These operations are linear, so devices constructed from only these operations will also be linear. These operations need not all be available in all cases. In particular, constant multiplications are not necessary, but instead aid efficiency. When this process is applied to the creation of digital electronic circuits, multiplications by 2×, for integer x, can be constructed using bit-shifts. Bit-shifts can be constructed at low cost or no cost, where cost is measured in terms of extra delay or silicon area.

To perform circuit optimisation, an evolutionary algorithm is provided, within which is a plurality of genetic operators. The algorithm and its genetic operators are used to implement the optimisation process in which the invention is embodied. This process has two distinct levels. At a first level, a population of initial circuits is identified or provided by or to the evolutionary algorithm. Each of the circuits within this population can be used to create a plurality of modified circuits using one or more of the genetic operators, in particular one or more mutation operators, each of the modified circuits being assessed to determine whether it provides improved characteristics. Each operator can perform a particular type of modification. For example, the genetic operator may be operable to change a connection wire. Examples of other genetic operators will be described in more detail later.

Heuristic searches are done within least some of the genetic operators to intelligently identify those circuits that have characteristics or parameters that are closest to the desired characteristics or parameters. Once identified, these improved circuits are then added to the population of solutions that the evolutionary algorithm-can act on. At the same time, the evolutionary algorithm is used to determine the fitness of all of the identified circuits within the population of circuits, thereby to determine which of these are closest to those desired. Good circuits are retained within the population and poor circuits are removed. The process is iterative, with the quality of the circuits within the population being continuously improved. By nesting the relatively faster but unreliable search of the genetic operators within the relatively slow, but generally reliable search provided by the evolutionary algorithm, there is provided a means for achieving a fast, but reliable search. Using a two level, iterative search process, the overall computation time can be greatly reduced. This is because the evolutionary algorithm does not have to act on all possible versions of the circuit, but instead acts on only those circuits already heuristically identified as being relatively close to the desired circuit.

The heuristics used in the present invention are provided within mutation operators. The heuristic mutation operators use knowledge of the specific problem domain defined by the user when making changes to the circuit design. The device or circuit may be represented by Directed Acyclic Graphs (DAGs) By “Graph” it is meant a set of nodes, some of which can be connected by edges; “Directed” means each edge connects to a source node and a destination node, that is both ends of an edge are not equivalent, and “Acyclic” means there are no loops, so that whichever edges are followed from source to destination, it is not possible to get back to the starting point. In the context of the present application, these graphs have nodes that correspond to computational components, and edges that correspond to the interconnections between components.

The heuristics used by the genetic operators are based around the idea that the value on each point, that is edge or node, in a graph representative of the circuit can be considered in isolation. The method may use a population of graphs. The graphs in the initial population can be trivial. The graphs in the initial population can be randomly generated. One or more types of genetic operator may be used to create modified versions of the graphs present in the population. The relationship between the value on an edge or at a node and the inputs and outputs of the complete design can be characterised. This is illustrated in FIG. 11. This characterisation allows for the intelligent alteration of the value on a particular edge, this being done by the genetic operators.

FIG. 11 shows a single edge, that is interconnection, labelled ‘X’, and the way in which the rest of the design relates to it. In this case, the design is linear, and so the value on the edge can be described using an array of coefficients:
a=(a₁, a₂, . . . , aₙ)^{T}

These coefficients characterise the relationship between the edge and the inputs. Another series of coefficients characterise the way in which the value on the edge changes each output:
b=(b₁, b₂, . . . bₘ)^{T}

For a design with n inputs and m outputs, the whole design can be described as:
R=b·a^{T}+C

where R is the m×n matrix containing the response of the design, and C is the m×n matrix containing the response of the section of the design that is independent of edge X. This is represented by the box labelled ‘linear subgraph’ at the top of FIG. 11. It should be noted that it is trivial to automatically calculate R for a design, and that it is also trivial to find a, b and C, for a particular edge in a design. Since for a given edge C is constant, it will be appreciated that minimal computational effort is required to determine the effect that a given value at that edge has on the outputs. This is because most of the time, only part of the circuit has to be modelled, that is the part connecting the node to the output. There is no need to re-do the characterisation for the entire circuit every time a modification is made. Hence, the characterisation information allows for the rapid modelling of this section of the design.

It can now be seen that the results of zeroing an edge, inserting a negation, inserting a multiplication, and adding the value of another wire are, respectively:
R=C
R=C−b·a^{T}
R=x·b·a^{T}+C, for some x
R=b·(a^{T}+a′^{T})+C
In the last of these equations, the vector a′ serves a similar purpose to a, but describes a different edge. Any change that can be made to an edge can be described using combinations of these operations.

If the user-specified target response is now introduced as the m×n matrix T, useful heuristics can be derived. The difference between the actual and ideal responses gives an error value, which should be corrected:
error=R−T
desired correction=T−R
It is also possible to find a value that should be added to edge X in order to reduce the error in the output. It is not usually possible to perfectly correct the outputs by changing a single edge, however a best-case correction can still be found. It is worth noting that edge X does not necessarily connect to every output. For this reason, a set S is defined, containing the indices of all of the outputs that edge X does connect to:
S={x|1≦x≦m, bₓ≠0}
This allows the desired correction d for edge X to be defined as:

$${d}_{i} = \frac{1}{\vert S \vert} {\sum }_{j ∈ S} \frac{{t}_{j , i} - {r}_{j , i}}{{b}_{j}}$$

The array d is a quantity that should be added onto a. Ideally changes should be made to the graph such that a is replaced with a+d. The ‘ideal’ value for a particular edge can be computed as follows:

$${e}_{i} = \frac{1}{\vert S \vert} {\sum }_{j ∈ S} \frac{{t}_{j , i}}{{b}_{j}}$$

where e is the ‘ideal’ vector.

In an optional extension to this technique, devices that make use of the addition or subtraction of constants can be used. In this case, the input vector is assumed to be an n+1 element vector of the form (i₁, . . . , iₙ, 1)^{T}. The device specification, response matrix and the vectors characterising how an edge relates to the inputs, can then be extended to include constant terms.

An extended form of this technique can be used for the design of non-linear devices. To allow for this, a notation for the characteristics of non-linear designs is necessary. The matrices that have been used so far are a shorthand representation of sets of linear equations. For example, a transform specified as follows:

$$( \begin{matrix}{o}_{1} \\ {o}_{2}\end{matrix} ) = ( \begin{matrix}1 & 2 & 3 \\ 4 & 5 & 6\end{matrix} ) ( \begin{matrix}{i}_{1} \\ {i}_{2} \\ {i}_{3}\end{matrix} )$$

can also be represented using a set of linear equations:
o₁=i₁+2i₂+3i₃
o₂=4i₁+5i₂+6i₃
As the use of matrices cannot easily be extended to non-linear systems, non-linear systems will be considered as being described by sets of equations. It should be noted that although the notation has changed, many of the manipulations performed on these sets of equations are equivalent to manipulations that were described earlier using matrices.

There are several classes of non-linear designs that could be created by a non-linear version of this technique. The most obvious application would be to extend the linear system so that it is capable of creating designs that include multipliers. Thus the design properties could be expressed using polynomials of higher order than the first-order (linear) polynomials that can describe linear systems. However, the arithmetic that is used to describe the designs does not need to be based upon linear operations, nor does it need to include the basic operations of addition and subtraction. For example, Boolean equations could be used.

In order for non-linear designs to be created, there must be one or more genetic operators for the insertion of non-linear components. These components may include, but are not limited to multiplicative components; a component that outputs whichever of two output values is largest; Boolean components such as ANDs, ORs and NOTs, and mathematical functions such as sines, cosines, logarithms, exponents, etc. The insertion of non-linear components could either be done heuristically or non-heuristically. As an example, a heuristic operator for the insertion of multiplicative components could work as follows. A first edge is chosen at random. The values of the outputs are found, but the value on the chosen edge is treated as an unknown factor in the output values. A search is then performed for a second edge, which when substituted in place of the unknowns in the output values, leads to a value that best minimises the differences between the output values and the specification. A multiplication can then be inserted into the design to perform this operation.

The characterisation for nodes and outputs is more complex for non-linear systems. The characterisation depends upon the type of non-linear components that are used. For example, designs that use adders and multipliers can be characterised using polynomial equations, whereas designs based on Boolean components can be characterised using truth tables. A further difference in approach when producing non-linear designs is that although the relationship between a node and the outputs can be characterised, it might not be possible to calculate an ideal value for the node. This happens when the inputs to a component cannot be found from the output value; this is the case for operations such as squaring or sines. In other words, the ideal value for a node cannot be found if some of the operations in the design are irreversible. When there is no ‘ideal’ value for a node, the search strategy must be altered. Rather than attempting to meet the ideal value for a particular node, changes in the output values are instead computed, and then compared with the specifications for the whole design. Although this is more computationally expensive than the scheme that does use an ideal value, it is still less expensive than propagating data all the way through the circuit design. The costs are still low because it is not necessary to calculate the effects of each individual component between the node and the outputs; instead, the effects of all of the relevant components can be computed in one large operation. The operation that is performed is a substitution operation. The value on the chosen edge is treated as an unknown factor in the output values. The possible values that the edge might take can then be substituted into the output values, in place of the unknown value. In many cases the computational cost of this single large operation is lower than the total cost of simulating many individual components. To reduce the size of the search, outputs that are not connected to a particular node can be ignored.

An implementation of this invention will now be described. This implementation generates optimised digital circuit designs using a two level, iterative optimisation. Initially, a device or circuit specification is received, for example, from the circuit designer. This device or circuit has desired characteristics. The aim of the method of the invention is to determine a computational circuit that can provide the characteristics that are closest to the desired characteristics. To start with, a population of circuits is provided. One of this initial population is selected. Modifications are made to a single feature of the selected design, with all the resulting modified circuits being characterised, as described previously, to determine which has characteristics that are closest to the desired characteristics. Once the optimised circuit is determined, it is added into the population of circuits. At this stage the initially selected circuit may or may not be eliminated from the population. Then another feature of the selected design is varied to provide a plurality of other possible circuits. Each of these modified circuits is characterised to determine which is best. Again, the best option is added to the population of possible circuits and stored. This process is repeated continuously until all possible or a pre-determined number of modifications have been tried.

Whilst the selected circuits of the population are being modified, each of the population of circuits is assessed using a fitness value to determine which of the population have features that are closest to the pre-determined specification. As a preferred option, this is done continuously as the population is being developed. Good circuits are retained and poor circuits are eliminated. Circuits that are retained can be graded to provide an at least partially ordered list of the best circuits.

Two different versions of the implementation have been developed, one that uses an evolutionary algorithm to assess the population of partially optimised circuits, as well as one that uses stochastic hill-climbing, as the search technique. In each case graphs are used to represent the digital circuit designs. Each node in a graph represents an addition. Each input to an addition can optionally be left-shifted. Either input to an addition can also optionally be negated, a possibility that allows for the description of subtractors. A node is illustrated in FIG. 12. The outputs of the entire circuit also have an optional shift and an optional negation.

Mathematically, a node can calculate the following expression:
nₐ19 2^{x}·a+n_{b}·2hu y·b
where a and b are inputs, x,y>=0 are shifts, and nₐ,n_{b} <in>(−1,1) decide whether an input is negated.

This system uses four genetic operators, which are shown in Table 1. These genetic operators are all mutational. Current versions of the EA have no crossover operator, although it will be appreciated that this could be included or implemented, if desired. Three of the genetic operators use heuristics, and are concerned with reduction of the functional error of the circuit. These are the insertion operator, the connection modification operator and the shift and/or negation operator. In this context, the term heuristic is intended to mean that the operator is based on a set of pre-determined rules for finding a solution. The other, non-heuristic operator removes components, possibly improving the area or latency of a circuit.

TABLE 1
The genetic operators.

| Operator | Probability |
|---|---|
| insertion of a new component | 0.25 |
| modification of a connection | 0.25 |
| modification of a shift | 0.25 |
| and/or negation | |
| component removal | 0.25 |

In use, one of these genetic operators is chosen at random, and a single change is made to each new circuit. The genetic operators for component insertion and connection modification change a random wire in the design. The wire can be one of the inputs for a component, or one of the outputs from the whole circuit. The fact that a random wire is altered means that these operators are stochastic.

The three heuristic operators all attempt to change the value on a wire by an amount matching the desired correction, d. This is not usually achievable, so the heuristic operators attempt to minimise the n-dimensional Euclidean distance between the actual and ideal values for a wire. The component insertion and connection modification operators consider all of the possibilities, and take the best. The shift and negation setting operator can always find the best settings using hill-climbing, rather than an exhaustive search.

The component insertion operation is illustrated in FIG. 13. It should be noted that all of the points in FIG. 13 are in n-dimensional space, where n is the number of inputs to the circuit. The distance in n-dimensional space between the actual and ideal values corresponds to the amount of error on the wire. The component insertion operator and the connection modification operator are very similar. The difference between the heuristics for these two operators is that the connection modification operator must subtract the existing value from a wire, before it searches for a new value to add to the wire. The actions that the connection modification operator takes are illustrated in FIG. 14.

The shift modification genetic operator uses hill-climbing to optimise the choice of shift and negation settings for a randomly chosen component input or circuit output. Choosing a shift and negation setting corresponds to multiplying the value on a wire by a factor in the set { . . . , −2²,−2¹, −2⁰,2⁰,2¹,2² . . . }. The shift modification operator can also remove a wire from the circuit, in effect achieving a multiplication by 0. The shift modification operator can always find the best choice of shift and negation settings. The task that this operator performs is shown in FIG. 15. The shift-changing operator uses hill-climbing to find the scale factor that results in the value that is closest to ideal, in this 22 example. The achievable values form a line in n-dimensional space.

The component removal operator is very simple. It selects a random component and removes it. When removing the component, one of the inputs, including a shift and optional negation, will be preserved, while the other input is eliminated. The component removal operator is intended to allow better exploration of the problem domain, and to allow bad designs to be repaired. It also aids the discovery of designs that are fast and that use a small silicon area.

The ‘component insertion’ and ‘connection modification’ operators consider every node in the design when choosing which modification to make. The computational efficiency of these operators could be improved if they only analysed a few nodes at random, although this could increase the number of generations until correct designs are found.

As mentioned previously, the graphs used by this system are acyclic. Cyclic graphs correspond to circuits that contain unclocked feedback loops. Such circuits will not perform a useful function, and can even cause physical damage to an IC due to excessive power consumption. For these reasons, any graph that is found to contain a cycle is replaced with a trivial acyclic graph.

The EA system uses a multi-objective EA with three objectives. The objectives are functional correctness, low silicon area, and low latency. Niching is used to encourage population diversity; solutions are rewarded if there are few similar solutions in the population. In a preferred embodiment, the EA has a population of 100 solutions. When creating a new population, the initial population is first increased in size to 200. The new solutions are mutated copies of existing solutions. The population size is then reduced down to 100 through the elimination of the worst solutions. Elitism is used, so that the very best solutions are guaranteed not to be eliminated.

The heuristic genetic operators do not necessarily have to be used with an evolutionary algorithm. A system which uses stochastic hill-climbing instead of an evolutionary algorithm has also been developed. This system uses the same style of mutation as the evolutionary algorithm system. The hill-climbing system requires less computational effort than the evolutionary algorithm system. However, the results tend to be of lower quality. These systems produce results suitable for inclusion on an integrated circuit.

An example of a useful application of the shift modifying genetic operator is shown in FIG. 16. In this case, the circuit is a multiplier, which ideally should multiply by a factor of 7. FIG. 16 shows the initial circuit before the application of the operator. This circuit performs multiplication by 2, which can be implemented as a 1-bit left shift. To improve upon the circuit shown in FIG. 16, the operator will consider a 0-bit shift (multiplication by 1) and a 2-bit shift (multiplication by 4). The impact of using each of the 0-bit shift and the 2-bit shift is considered and compared with the desired result and the initial circuit to determine which one gives a value that is closest to the desired value. In this case, the 0-bit shift gives worse results than the original 1-bit shift. The 2-bit shift is better than the 1-bit shift, so this shift is kept, and the search continues for increasing shift values. Further improvements are achieved with a 3-bit shift (multiplication by 8). A 4-bit shift (multiplication by 16) is worse than a 3-bit shift, so the search stops, producing the circuit of FIG. 17. This circuit performs a multiplication by 8 rather than a multiplication by 7, so it is still not perfect. However, it is better than the original design. The new circuit is also the best circuit that can be achieved only through modification of the shift. Further improvements require additional components. It should be noted that there is no point in considering shift values lower than 0 (right-shifts; divisions by a power of 2) or greater than 4. There is a single best shift value, and greater or smaller shifts are progressively worse.

FIGS. 18 and 19 illustrate an example of how the connection modifying operator can be used. In each of FIGS. 18 and 19, the circuit has two inputs, Y and Z. In this case, two outputs are desired, these being 6Y+Z and Y+Z. FIG. 18 shows the initial circuit before modification. In this example, the lower input to the uppermost adder is modified. The existing value is Z−Y, and the possible values that it could take are: Y, Z, Z−Y, or Y+Z. A change at this point in the circuit can only affect the upper output, so the lower output can be ignored. If the value Z−Y is replaced with 0, the upper output will have a value of 4Y. The 0 can then be replaced with Y, Z, Z−Y, and Y+Z, and the corresponding output values discovered. The most suitable output value is chosen, and the appropriate modification is made to the circuit.

FIG. 19 shows one possible modified circuit. In this circuit the value Z−Y in FIG. 18 has been replaced with the value Y+Z. This has caused the upper output to change to 5Y+Z from 3Y+Z. It can be seen that the change has also resulted in the elimination of one component. The genetic operator assesses each of circuits of FIGS. 18 and 19 to determine which has a specification that is closest to the desired specification. This is done by comparing the matrix associated with each of the circuits and the matrix for the desired circuit. At this stage, the assessment made by the operator only takes into account the changes that affect the upper output. It disregards features that remain unchanged. Because of this, the overall processing time to determine which circuit is better is reduced. In contrast, in known systems to assess the fitness of a circuit the entire circuit characteristics have to be taken into account every time a different circuit is assessed, which significantly increases processing time.

FIGS. 18 and 19 illustrate a simple example. There are two things that can further complicate the computation. One is if there is if there is a multiplication between the point at which the change is made, and the circuit output. In that case, the value that is modified will relate to the output value by a factor, rather than directly. Another complication is that a single point in the circuit can connect to multiple circuit outputs. If that is the case, the circuit can be changed so as to minimise the average of the errors on the connected outputs.

When outputting the final designs, any suitable format can be used, for example Verilog or VHDL or any other HDL.

The invention provides a method for automatically creating optimised computational devices. The computational devices perform linear or non-linear transforms. The basic form of this invention can create devices that perform linear transforms, and an extended form of the invention can be used for the design of non-linear devices. The designs are created from a user-supplied specification. Aside from the specification, no further user intervention is required in order to produce a design. By using an evolutionary algorithm, which is relatively slow, but robust, together with a heuristic operator, which is fast, but not as robust, there is provided an unexpectedly good mechanism for identifying optimal arrangements for computational devices circuits, based on input specifications.

In one embodiment, the invention can be used to create digital circuits, for example multiplierless digital circuits that perform linear transforms. Another possibility is that the invention could be used to create computer programs. If a circuit can be made from, for example adders and subtracters, an equivalent computer program can be created, using addition instructions and subtraction instructions instead of hardware components. Other possibilities include linear analogue circuits or even mechanical (clockwork) computation.

The design tool in which the invention is embodied provides many advantages. For example, with the ever-escalating complexities of modern VLSI designs, it is inevitable that the occasional bug may protrude into an IP block previously published. In the dynamic environment proposed herein, any alterations to a live library component are in immediate effect for all clients subsequently wishing to compile or synthesise a design incorporating that component.

A skilled person will appreciate that variations of the disclosed arrangements are possible without departing from the invention. Accordingly, the above description of a specific embodiment is made by way of example only and not for the purposes of limitation. It will be clear to the skilled person that minor modifications may be made without significant changes to the operation described.

1. A method for designing a computational device or circuit having one or more desired characteristics, preferably input and/or output characteristics, the method involving:
using an inner, iterative search: selecting one of a population of computational circuits or devices having known or calculable input(s) and/or output(s) characteristics; selecting a point in the selected circuit or device; characterising that point in terms of the circuit or device input(s) and/or output(s); modifying a parameter or characteristic associated with the selected point; re-characterising the selected, modified point in terms of the circuit or device input(s) and/or output(s); repeating the steps of modifying, and characterising; identifying which of the selected or modified circuits has characteristics closest to the desired characteristics, and adding the identified circuit to the population of circuits, and repeating all steps for another one of the population, and
using an outer search: iteratively searching the population to determine the circuits or devices having characteristics that are closest to the desired characteristics.

2. A method as claimed in claim 1 comprising removing poorer quality circuits from the population.

3. A method as claimed in claim 1, wherein the outer search is done using a stochastic algorithm such as an evolutionary algorithm and/or a hill-climbing search or other such search technique.

4. A method as claimed in claim 3, wherein the inner search is used within one or more genetic operators.

5. A method as claimed in claim 4, wherein the or each genetic operator is provided within the stochastic algorithm or other such search.

6. A method as claimed in claim 4, wherein one or more of the genetic operators is operable to use a heuristic technique in the step of modifying.

7. A method as claimed in claim 6, wherein the genetic operator is adapted to modify the parameter or characteristic associated with the selected point by doing any one or more of: inserting a new component; modifying a connection or modifying a shift or a negation.

8. A method as claimed in claim 4, wherein the genetic operator modify the initial circuit by removing one or more components.

9. A method as claimed in claim 1, wherein the computational circuit or device is linear and is characterised as follows:
R=b·a^{T}+C
where R is an m×n matrix containing the response of the circuit or device; a^{T} is an array of coefficients that characterises the relationship between the selected point and the circuit inputs; b is an array of coefficients that characterises the relationship between the selected point and the circuit outputs, and C is an m×n matrix containing the response of a section of the design that is independent of the selected point.

10. A method as claimed in claim 1, wherein the circuit or device is non-linear.

11. A method as claimed in claim 1, wherein the device or circuit is represented by a directed acyclic graph (DAG).

12. A computer program for designing a computational device or circuit having one or more desired characteristics, preferably input and/or output characteristics, the computer program having code or instructions for implementing inner and outer iterative searches,
the inner search involving selecting one of a population of computational circuits or devices having known or calculable input(s) and/or output(s) characteristics; selecting a point in the selected circuit or device; characterising that point in terms of the circuit or device input(s) and/or output(s); modifying a parameter or characteristic associated with the selected point; re-characterising the selected, modified point in terms of the input(s) and/or output(s); repeating the steps of modifying, and characterising; identifying which of the selected or modified circuits has characteristics closest to the desired characteristics, and adding the identified circuit to the population of circuits, repeating this for another one of the population, and
the outer search involving iteratively searching the population to determine the circuits or devices having characteristics that are closest to the desired characteristics.

13. A design tool for designing a computational device or circuit having one or more desired characteristics, preferably input and/or output characteristics, the tool comprising:
means for implementing an inner, iterative search that involves selecting one of a population of computational circuits or devices having known or calculable input(s) and/or output(s) characteristics; selecting a point in the selected circuit or device; characterising that point in terms of the circuit or device input(s) and/or output(s); modifying a parameter or characteristic associated with the selected point; re-characterising the selected, modified point in terms of the input(s) and/or output(s); repeating the steps of modifying, and characterising; identifying which of the selected or modified circuits has characteristics closest to the desired characteristics, and adding the identified circuit to the population of circuits, and repeating all steps of the inner search for another one of the population, and
means for implementing an outer search that involves iteratively searching the population to determine the circuits or devices having characteristics that are closest to the desired characteristics.

14. A method for designing a computational device or circuit having one or more desired characteristics, preferably input and/or output characteristic, the method involving selecting a point in a computational circuit or device having known or calculable input and/or output characteristics; characterising that point in terms of the circuit or device input(s) and/or output(s); modifying a parameter or characteristic associated with the selected point; re-characterising the selected, modified point in terms of the input(s) and output(s); repeating the steps of modifying, and characterising, and identifying which of the selected or modified circuits has characteristics closest to the desired characteristics.

15. A method for designing a computational device or circuit having one or more desired characteristics, preferably input and/or output characteristic comprising:
using an inner search to: select one of a population of initial computational circuits or devices having known or calculable input(s) and/or output(s) characteristics; modify the selected circuit using a heuristic operator; determine one or more characteristics of the modified circuit; in the event that an improved circuit is found, add that improved version of the circuit to the population of circuits; and iteratively repeat the steps of selecting, modifying, determining and adding, and
using an outer search: iteratively searching the population to determine the circuits or devices having characteristics that are closest to the desired characteristics.

16. A design tool for designing a computational device or circuit having one or more desired characteristics, preferably input and/or output characteristic, the tool comprising:
means for implementing an inner search that involves selecting one of a population of initial computational circuits or devices having known or calculable input and/or output characteristics; modifying the selected circuit using a heuristic operator; determining one or more characteristics of the modified circuit; adding the improved version of the circuit to the population of circuits, in the event that an improved circuit is found; and iteratively repeating the steps of selecting, modifying, determining and adding, and
means for implementing an outer search that involves iteratively searching the population to determine the circuits or devices having characteristics that are closest to the desired characteristics.

17. (canceled)

18. (canceled)

19. (canceled)

20. (canceled)

21. A method for designing circuits, the method comprising maintaining a plurality of user selectable representations of electronic components or devices; receiving from a user terminal a user selection of one of the components or devices; sending a signal to the user terminal for causing a symbol representative of the selected device to be generated; receiving a symbol based design from the user terminal; using the symbols to identify the selected components or devices and creating a circuit representing the symbol based design.

22. A method as claimed in claim 21, further involving receiving a user-defined characteristic; determining components or devices having that characteristic and providing one or more user selectable identifiers associated with each of the components or devices found.

23. A method as claimed in claim 21, wherein the user selectable representation of the electronic component or device is an identifier associated with a pre-verified hardware core module for implementing that component or device.

24. (canceled)

25. A device or circuit that is made according to a design devised using the method and/or computer program and/or design tool and/or system defined in claim 21.
